(19) United States
(12) Patent Application Publication
(10) Pub. No.: US 2010/0033810 A1
(43) Pub. Date: Feb. 11, 2010

(54) POLARIZER PROTECTIVE FILM, POLARIZING PLATE, AND IMAGE DISPLAY APPARATUS

(75) Inventors: Nobuyuki Haida, Osaka (JP); Daisuke Hattori, Osaka (JP); Tsutomu Hani, Osaka (JP); Hiroyuki Takao, Osaka (JP); Hitoshi Kitagishi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/520,140

(22) PCT Filed: Dec. 5, 2007
(86) PCT No.: PCT/JP2007/073448

§ 371 Date: Jun. 19, 2009

(30) Foreign Application Priority Data
Dec. 27, 2006 (JP) 2006-351347

(51) Int. Cl. G02B 5/20; G02B 5/30

(52) U.S. Cl. 359/361; 359/502

(57) ABSTRACT

Provided is a polarizer protective film of thin type, which has excellent heat resistance and excellent transparency as well as excellent UV-absorbing ability, has good external appearance of a film surface, and can be stably produced by film forming. The polarizer protective film of the present invention includes a resin layer (A) and a resin layer (B1) in the stated order, in which the resin layer (A) is a resin layer containing a (meth)acrylic resin as a main component and contains a UV absorber at a ratio of 0.5 to 10 wt % with respect to a resin component contained in the resin layer (A), and the resin layer (B1) is a resin layer containing, as a main component, a thermoplastic resin other than a (meth) acrylic resin.

### TECHNICAL FIELD

The present invention relates to a polarizer protective film, a polarizing plate using the polarizer protective film, and an image display apparatus such as a liquid crystal display apparatus, an organic EL display apparatus, or a PDP including at least one polarizing plate.

### BACKGROUND ART

A liquid crystal display apparatus must have polarizing plates arranged on both sides of a glass substrate forming the surface of a liquid crystal panel due to its image forming system. Such a polarizing plate to be used is generally manufactured by attaching a polarizer protective film formed by using triacetyl cellulose or the like on both sides of a polarizer made of a polyvinyl alcohol-based film and a dichromatic substance such as iodine by using a polyvinyl alcohol-based adhesive.

The polarizer protective film may be required to have UV-absorbing ability for the purpose of preventing liquid crystal and the polarizer from being degraded by UV-light. Currently, a UV absorber is added to a triacetyl cellulose film as the polarizer protective film, whereby the polarizer protective film is provided with UV-absorbing ability.

However, triacetyl cellulose has insufficient heat and humidity resistance and thus has a problem in that properties such as a polarization degree and a hue of a polarizing plate degrade when a polarizing plate using the triacetyl cellulose film as a polarizer protective film is used under high temperature or high humidity conditions. Further, the triacetyl cellulose film causes retardation with respect to incident light in an oblique direction. With the increase in size of a liquid crystal display in recent years, the retardation has had significant effects on viewing angle properties.

As a material for the polarizer protective film that replaces conventionally used triacetyl cellulose, a transparent thermoplastic resin has been considered, and a polarizer protective film that is provided with UV-absorbing ability by adding a UV absorber to a transparent thermoplastic resin has been also reported (see Patent Documents 1 and 2). However, in the case where a (meth) acrylic resin having excellent heat resistance is adopted as the transparent thermoplastic resin, there are some cases where the UV absorber is volatilized at the time of film forming (such as extrusion molding) at high temperature and causes deposition and aggregation at a forming outlet (such as an extrusion outlet). Further, the UV absorber floats up on the surface of a formed film, and the UV absorber may be attached to the surface of a roll at the time of transporting or winding up the film. In the case of performing film forming in the above state, there arise problems that a scratch on the film surface or an adhesion of a foreign material on the film surface occurs, and that a stable operation of a forming machine cannot be guaranteed. Further, a reduction in the thickness of a polarizer protective film is strongly desired along with the recent reduction in the thickness of an image display apparatus.

### Patent Document 1: JP 09-166711 A

### Patent Document 2: JP 2004-45893 A

### DISCLOSURE OF THE INVENTION

### Problems to be Solved by the Invention

The present invention has been made in view of solving the above-mentioned conventional problems, and an object of the present invention is to provide: (1) a polarizer protective film of thin type, which has excellent heat resistance and excellent transparency as well as excellent UV-absorbing ability, has good external appearance of a film surface, and can be stably produced by film forming; (2) a polarizing plate having few external appearance defects, which includes the polarizer protective film and a polarizer formed of a polyvinyl alcohol-based resin; and (3) an image display apparatus of high quality, which includes the polarizing plate.

### Means for Solving the Problems

A polarizer protective film of the present invention includes, in the following order: a resin layer (A); and a resin layer (B1), in which:

the resin layer (A) is a resin layer containing a (meth) acrylic resin as a main component and contains a UV absorber at a ratio of 0.5 to 10 wt % with respect to a resin component contained in the resin layer (A); and

the resin layer (B1) is a resin layer containing, as a main component, a thermoplastic resin other than a (meth) acrylic resin.

In a preferred embodiment, the resin layer (B1) contains a UV absorber at a ratio of more than 0 wt % and 2 wt % or less with respect to a resin component contained in the resin layer (B1).

In a preferred embodiment, a content ratio of the UV absorber in the resin layer (B1) is less than a content ratio of the UV absorber in the resin layer (A).

In a preferred embodiment, the resin layer (B1) has a thickness of 0.5 to 15 μm and the resin layer (A) has a thickness of 5 to 70 μm.

In a preferred embodiment, the thermoplastic resin other than a (meth)acrylic resin includes at least one kind selected from a polyamide-based resin, a polycarbonate-based resin, a polystyrene-based resin, a polyolefin-based resin, a polyester-based resin, a polyether-based resin, and a polyphenylene-based resin.

In a preferred embodiment, the polarizer protective film of the present invention includes a resin layer (B2) on a resin layer (A) side opposite to a side on which the resin layer (B1) is provided, in which the resin layer (B2) is a resin layer containing a thermoplastic resin as a main component.

In a preferred embodiment, the resin layer (B2) is a resin layer containing, as a main component, a thermoplastic resin other than a (meth)acrylic resin.

In a preferred embodiment, the thermoplastic resin other than a (meth)acrylic resin includes at least one kind selected from a polyamide-based resin, a polycarbonate-based resin, a polystyrene-based resin, a polyolefin-based resin, a polyester-based resin, a polyether-based resin, and a polyphenylene-based resin.

In a preferred embodiment, the resin layer (B2) contains a UV absorber at a ratio of more than 0 wt % and 2 wt % or less with respect to a resin component contained in the resin layer (B2).

In a preferred embodiment, a content ratio of the UV absorber in the resin layer (B1) and a content ratio of the UV absorber in the resin layer (B2) are each less than a content ratio of the UV absorber in the resin layer (A).

In a preferred embodiment, the resin layer (B1) has a thickness of 0.5 to 15 μm, the resin layer (A) has a thickness of 5 to 70 μm, and the resin layer (B2) has a thickness of 0.5 to 15 μm.

In a preferred embodiment, the polarizer protective film of the present invention has a total thickness of 15 to 100 μm.

In a preferred embodiment, the polarizer protective film of the present invention has a light transmittance at 380 nm in a thickness of 50 μm of 10% or less.

In a preferred embodiment, the polarizer protective film of the present invention is produced by a coextrusion molding.

According to another aspect of the present invention, a polarizing plate is provided. The polarizing plate of the present invention includes a polarizer formed of a polyvinyl alcohol-based resin and the polarizer protective film of the present invention.

In a preferred embodiment, the polarizing plate of the present invention includes an adhesive layer formed between the polarizer protective film and the polarizer.

In a preferred embodiment, the adhesive layer is formed of a polyvinyl alcohol-based adhesive.

In a preferred embodiment, the polarizing plate of the present invention further includes a pressure-sensitive adhesive layer on at least one side of resin layers.

According to another aspect of the present invention, an image display apparatus is provided. The image display apparatus of the present invention includes at least one polarizing plate of the present invention.

### EFFECTS OF THE INVENTION

According to the present invention, there can be provided: the polarizer protective film of thin type, which has excellent heat resistance and excellent transparency as well as excellent UV-absorbing ability, has good external appearance of a film surface, and can be stably produced by film forming; the polarizing plate having few external appearance defects, which includes the polarizer protective film and a polarizer formed of a polyvinyl alcohol-based resin; and the image display apparatus of high quality, which includes the polarizing plate.

When a UV absorber is added to a (meth) acrylic resin having excellent heat resistance and transparency with the aim of exhibiting high heat resistance and high transparency as well as excellent UV-absorbing ability, the UV absorber is volatilized at the time of film forming (such as extrusion molding) at high temperature and causes deposition and aggregation at a forming outlet (such as an extrusion outlet). Further, the UV absorber floats up on the surface of a formed film, and the UV absorber may be attached to the surface of a roll at the time of transporting or winding up the film. In the case of performing film forming in the above state, there arise problems that a scratch on the film surface or an adhesion of a foreign material on the film surface occurs, and that a stable operation of a forming machine cannot be guaranteed.

As in the present invention, the resin layer (B1) containing a thermoplastic resin other than a (meth)acrylic resin as a main component is placed on one side of the resin layer (A), which is a resin layer containing a (meth) acrylic resin as a main component and contains a UV absorber at a ratio of 0.5 to 10 wt % in the resin layer, whereby there can be provided the polarizer protective film of thin type, which has excellent heat resistance and excellent transparency as well as excellent UV-absorbing ability, has good external appearance of a film surface, and can be stably produced by film forming. Particularly in extrusion molding, the above-mentioned effects can be further exhibited by setting a resin layer (B1) side of a film extruded from a T-die to correspond with the roll side of a cast roll at the time of winding up the film.

Further, the resin layer (B1) is a resin layer containing, as a main component, a thermoplastic resin other than a (meth) acrylic resin, and hence, the compatibility of the UV absorber to the resin layer (B1) is enhanced. Therefore, additionally excellent UV-absorbing ability can be exhibited only by adding a small amount of UV absorber to the resin layer (B1).

### BRIEF DESCRIPTION OF THE DRAWINGS

FIG. 1 is a cross-sectional view illustrating an example of a polarizer protective film of the present invention.

FIG. 2 is a cross-sectional view illustrating an example of a polarizing plate of the present invention.

FIG. 3 is a schematic cross-sectional view illustrating a liquid crystal display apparatus according to a preferred embodiment of the present invention.

### DESCRIPTION OF SYMBOLS

1 resin layer (B1)
2 resin layer (A)
3 resin layer (B2)
10 liquid crystal cell
11, 11′ glass substrate
12 liquid crystal layer
13 spacer
20, 20′ retardation film
30, 30′ polarizing plate
31 polarizer
32 adhesive layer
33 easy adhesion layer
34 polarizer protective film
35 adhesive layer
36 polarizer protective film
40 light guide plate
50 light source
60 reflector
100 liquid crystal display apparatus

### BEST MODE FOR CARRYING OUT THE INVENTION

Hereinafter, description of preferred embodiments of the present invention is given, but the present invention is not limited to the embodiments.

### [Polarizer Protective Film]

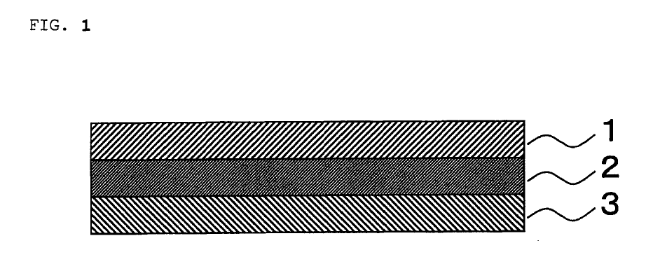

The polarizer protective film of the present invention includes a resin layer (A) and a resin layer (B1) in the stated order. This layer structure makes it possible that the resin layer (B1) suppresses a bleed out of a UV absorber from the resin layer (A) which contains a comparatively large amount of the UV absorber. For example, in extrusion molding, the occurrence of an attached substance on a cast roll can be suppressed by setting a resin layer (B1) side of a film extruded from a T-die to correspond with the roll side of the cast roll at the time of winding up the film. It is preferred that the polarizer protective film has a resin layer (B2) on a resin layer (A) side opposite to a side on which the resin layer (B1) is provided. That is, as a preferred embodiment, as shown in FIG. 1, the polarizer protective film has a resin layer (B1) 1, a resin layer (A) 2, and a resin layer (B2) 3 in the stated order.

The thickness of the resin layer (A) is preferably 5 to 70 μm, more preferably 10 to 60 μm, still more preferably 15 to 60 μm, and particularly preferably 30 to 50 μm. In the case where the thickness of the resin layer (A) is less than 5 μm, mechanical strength as a polarizer protective film may become poor and the UV-absorbing ability of the polarizer protective film may deteriorate. In the case where the thickness of the resin layer (A) is larger than 70 μm, the thickness as a polarizer protective film may become too large and the volatilization of a UV absorber may not be sufficiently suppressed by the resin layers (B1) and (B2).

The thickness of the resin layer (B1) is preferably 0.5 to 15 μm, more preferably 1 to 10 μm, still more preferably 1.5 to 8 μm, and particularly preferably 2 to 7 μm. In the case where the thickness of the resin layer (B1) is less than 0.5 μm, the mechanical strength of the resin layer (B1) may become poor and the volatilization of a UV absorber contained in the resin layer (A) may not be sufficiently suppressed. When the thickness of the resin layer (B1) is larger than 15 μm, the thickness as a polarizer protective film may become too large.

The thickness of the resin layer (B2) is preferably 0.5 to 15 μm, more preferably 1 to 10 μm, still more preferably 1.5 to 8 μm, and particularly preferably 2 to 7 μm. In the case where the thickness of the resin layer (B2) is less than 0.5 μm, the mechanical strength of the resin layer (B2) may become poor and the volatilization of a UV absorber contained in the resin layer (A) may not be sufficiently suppressed. When the thickness of the resin layer (B2) is larger than 15 μm, the thickness as a polarizer protective film may become too large.

The total thickness of the polarizer protective film of the present invention is preferably 15 to 100 μm, more preferably 18 to 90 μm, and still more preferably 20 to 80 μm. When the thickness of the polarizer protective film is 15 μm or more, the polarizer protective film has appropriate strength and rigidity and can be handled satisfactorily during secondary processing such as lamination and printing. Further, the retardation occurring due to the stress during take-up can be controlled easily, and the film can be produced stably and easily. When the thickness of the polarizer protective film is 100 μm or less, the film can be easily wound up, and a line speed, productivity, and controllability become satisfactory.

The resin layer (A) is a resin layer containing a (meth)acrylic resin as a main component and contains a UV absorber. The resin layer (B1) contains, as a main component, a thermoplastic resin other than a (meth)acrylic resin. The resin layer (B2) contains a thermoplastic resin as a main component. One kind of resin component or two more kinds of the resin components may be contained in each of the layers.

The Tg (glass transition temperature) of the (meth)acrylic resin is, for example, preferably 115° C. or higher, more preferably 120° C. or higher, and still more preferably 125° C. or higher. By including a (meth)acrylic resin having Tg (glass transition temperature) of 115° C. or higher as a main component, for example, in a case where the (meth)acrylic resin having such Tg is finally incorporated in a polarizing plate, the polarizing plate is likely to have excellent durability. The upper limit value of Tg of the above-mentioned (meth)acrylic resins is not particularly limited. However, it is preferably 170° C. or lower in view of a forming property and the like. Examples of the (meth)acrylic resin include a poly(meth)acrylate such as polymethylmethacrylate, a methyl methacrylate-(meth)acrylic acid copolymer, a methyl methacrylate-(meth)acrylate copolymer, a methyl methacrylate-acrylate-(meth)acrylic acid copolymer, a methyl (meth)acrylate-styrene copolymer (MS resin, etc.), and a polymer having an alicyclic hydrocarbon group (e.g., a methyl methacrylate-cyclohexyl methacrylate copolymer, a methyl methacrylate-norbornyl (meth)acrylate copolymer, etc.). Examples of the (meth)acrylic resin include preferably a C₁₋₆ alkyl poly(meth)acrylate such as methyl poly(meth)acrylate, and more preferably methyl methacrylate-based resin containing as a main component methyl methacrylate (50 to 100 wt %, preferably 70 to 100 wt %). Further, examples of the (meth) acrylic resin include ACRYPET VH and ACRYPET VRL20A manufactured by Mitsubishi Rayon Co., Ltd., a (meth) acrylic resin having a ring system in the molecule described in JP 2004-70296 A, and a (meth) acrylic resin having high Tg obtained by intramolecular cross-linking and intramolecular cyclization. Still further, examples of the (meth)acrylic resin include (meth) acrylic resins having a lactone ring structure described in JP 2000-230016 A, JP 2001-151814 A, JP 2002-120326 A, JP 2002-254544 A, and JP 2005-146084 A.

The (meth)acrylic resin having a lactone ring structure preferably has a lactone ring structure represented by the following General Formula (1).

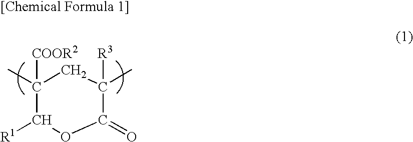

(In General Formula (I), R¹, R², and R³ independently represent hydrogen atoms or organic residues having 1 to 20 carbon atoms. The organic residues may contain oxygen atoms.)

The content ratio of the lactone ring structure represented by General Formula (1) in the structure of the (meth)acrylic resin having a lactone ring structure is preferably 5 to 90 wt %, more preferably 10 to 70 wt %, still more preferably 10 to 60 wt %, and particularly preferably 10 to 50 wt %. When the content ratio of the lactone ring structure represented by General Formula (1) in the structure of the (meth)acrylic resin having a lactone ring structure is smaller than 5 wt %, the heat resistance, solvent resistance, and surface hardness may become insufficient. When the content ratio of the lactone ring structure represented by General Formula (1) in the structure of the (meth)acrylic resin having a lactone ring structure is larger than 90 wt %, the forming property may become poor.

The mass average molecular weight (which may be referred to as weight average molecular weight) of the (meth)acrylic resin having a lactone ring structure is preferably 1,000 to 2,000,000, more preferably 5,000 to 1,000,000, still more preferably 10,000 to 500,000, and particularly preferably 50,000 to 500,000. When the mass average molecular weight is out of the above range, the effects of the present invention may not be exhibited sufficiently.

The glass transition temperature (Tg) of the (meth) acrylic resin having a lactone ring structure is preferably 115° C. or higher, more preferably 125° C. or higher, still more preferably 130° C. or higher, particularly preferably 135° C. or higher, and most preferably 140° C. or higher. For example, when Tg is 115° C. or higher, the polarizer protective film may have excellent durability when the (meth)acrylic resin is incorporated in a polarizing plate as a polarizer protective film. The upper limit value of Tg of the (meth)acrylic resin having a lactone ring structure is not particularly limited. However, it is preferably 170° C. or lower in view of the forming property and the like.

Regarding the (meth)acrylic resin having a lactone ring structure, the total light transmittance measured by a method pursuant to ASTM-D-1003 of a molding obtained by injection molding is preferably as high as possible, and is preferably 85% or higher, more preferably 88% or higher, and still more preferably 90% or higher. The total light transmittance is an index of transparency. When the total light transparency is less than 85%, the transparency decreases, which may make it impossible to use the resultant as a polarizer protective film.

The content of the (meth) acrylic resin contained in the resin layer (A) included in the polarizer protective film of the present invention is preferably 50 to 99 wt %, more preferably more than 50 wt % and 99 wt % or less, still more preferably 60 to 98 wt %, and particularly preferably 70 to 97 wt %. In the case where the content of the (meth)acrylic resin is less than 50 wt %, the high heat resistance and high transparency originally owned by a (meth) acrylic resin may not be reflected sufficiently. In the case where the content of the (meth) acrylic resin exceeds 99 wt %, the mechanical strength may become poor.

A resin component other than the (meth) acrylic resin may be contained in the resin layer (A) in the polarizer protective film of the present invention. As the resin component other than the (meth) acrylic resin, any appropriate resin component may be employed in such a range that the effect of the present invention is not adversely affected.

The content of the (meth) acrylic resin in the material, which is to be formed into the resin layer (A) and used for forming the polarizer protective film of the present invention, is preferably 50 to 99 wt %, more preferably more than 50 wt % and 99 wt % or less, still more preferably 60 to 98 wt %, and particularly preferably 70 to 97 wt %. In the case where the content of the (meth)acrylic resin is less than 50 wt %, the high heat resistance and high transparency originally owned by a (meth)acrylic resin may not be reflected sufficiently. In the case where the content of the (meth)acrylic resin exceeds 99 wt %, the mechanical strength of the resin layer (A) may become poor.

A resin component other than the (meth)acrylic resin may be contained in the material which is to be formed into the resin layer (A) and used for forming the polarizer protective film of the present invention. As the resin component other than the (meth) acrylic resin, any appropriate resin component may be employed in such a range that the effect of the present invention is not adversely affected.

As the thermoplastic resin other than a (meth) acrylic resin, any appropriate thermoplastic resin can be employed. Preferred is at least one kind selected from a polyamide-based resin, a polycarbonate-based resin, a polystyrene-based resin, a polyolefin-based resin, a polyester-based resin, a polyether-based resin, and a polyphenylene-based resin.

As the polyamide-based resin, any appropriate polyamide-based resin can be employed. Specific examples thereof include: nylon-based resins such as nylon 6 and nylon 66; all aromatic polyamides such as aramid; and denatured products and copolymers thereof.

As the polycarbonate-based resin, any appropriate polycarbonate-based resin can be employed. Specific examples thereof include: polycarbonate; and denatured products and copolymers thereof.

As the polystyrene-based resin, any appropriate polystyrene-based resin can be employed. Specific examples thereof include: polystyrene; an ABS resin (acrylonitrile-butadiene-styrene copolymer resin); an AS resin (acrylonitrile-styrene copolymer resin); an AAS resin (an ABS resin in which an acrylic rubber is used instead of a butadiene rubber); an ACS resin (an ABS resin in which a chlorinated polyethylene is used instead of a butadiene rubber); an AES resin (an ABS resin in which an EPDM rubber is used instead of a butadiene rubber); an MS resin (methyl methacrylate-styrene copolymer resin); an SMA resin (styrene-maleic anhydride copolymer resin); and denatured products and copolymers thereof.

As the polyolefin-based resin, any appropriate polyolefin-based resin can be employed. Specific examples thereof include: polyethylene; polypropylene; ethylene-based copolymers such as EVA (ethylene-vinyl acetate copolymer) and EEA (ethylene-ethyl acrylate copolymer); an ionomer; and denatured products and copolymers thereof.

As the polyester-based resin, any appropriate polyester-based resin can be employed. Specific examples thereof include: PET (polyethylene terephthalate); PEN (polyethylene naphthalate); PBT (polybutyleneterephthalate); and denatured products and copolymers thereof.

As the polyether-based resin, any appropriate polyether-based resin can be employed. Specific examples thereof include: polyacetal; and denatured products and copolymers thereof.

As the polyphenylene-based resin, any appropriate polyphenylene-based resin can be employed. Specific examples thereof include polyphenylene ether; polyphenylene sulfide; and denatured products and copolymers thereof.

As the thermoplastic resin other than a (meth) acrylic resin, which can be used in the present invention, more preferred is a polystyrene-based resin and particularly preferred is an AS resin (acrylonitrile-styrene copolymer resin).

The content of the thermoplastic resin other than a (meth) acrylic resin in the resin layer (B1) included in the polarizer protective film of the present invention is preferably 50 to 99 wt %, more preferably more than 50 wt % and 99 wt % or less, still more preferably 60 to 98 wt %, and particularly preferably 70 to 97 wt %. In the case where the content of the thermoplastic resin other than a (meth) acrylic resin is less than 50 wt %, the high heat resistance and high transparency originally owned by the thermoplastic resin other than a thermoplastic resin other than a (meth)acrylic resin may not be reflected sufficiently. In the case where the content of the thermoplastic resin other than a (meth) acrylic resin exceeds 99 wt %, the mechanical strength of the resin layer (B1) may become poor.

A resin component other than the “thermoplastic resin other than a (meth)acrylic resin” may be contained in the resin layer (B1) included in the polarizer protective film of the present invention. As the resin component other than the “thermoplastic resin other than a (meth)acrylic resin”, any appropriate resin component may be employed in such a range that the effect of the present invention is not adversely affected.

The content of the thermoplastic resin other than a (meth)acrylic resin in the material, which is to be formed into the resin layer (B1) and used for forming the polarizer protective film of the present invention, is preferably 50 to 99 wt %, more preferably more than 50 wt % and 99 wt % or less, still more preferably 60 to 98 wt %, and particularly preferably 70 to 97 wt %. In the case where the content of the thermoplastic resin other than a (meth)acrylic resin is less than 50 wt %, the high heat resistance and high transparency originally owned by the thermoplastic resin other than a (meth) acrylic resin may not be reflected sufficiently. In the case where the content of the thermoplastic resin other than a (meth)acrylic resin exceeds 99 wt %, the mechanical strength of the resin layer (B1) may become poor.

A resin component other than the “thermoplastic resin other than a (meth) acrylic resin” may be contained in the material which is to be formed into the resin layer (B1) and used for forming the polarizer protective film of the present invention. As the resin component other than the “thermoplastic resin other than a (meth)acrylic resin”, any appropriate resin component may be employed in such a range that the effect of the present invention is not adversely affected.

The content of the thermoplastic resin in the resin layer (B2) included in the polarizer protective film of the present invention is preferably 50 to 99 wt %, more preferably more than 50 wt % and 99 wt % or less, still more preferably 60 to 98 wt %, and particularly preferably 70 to 97 wt %. In the case where the content of the thermoplastic resin is less than 50 wt %, the high heat resistance and high transparency originally owned by a thermoplastic resin may not be reflected sufficiently. In the case where the content of the thermoplastic resin exceeds 99 wt %, the mechanical strength of the resin layer (B2) may become poor. Note that the above content of the thermoplastic resin is also applied to the content of the thermoplastic resin in the material, which is to be formed into the resin layer (B2) and used for forming the polarizer protective film of the present invention.

A resin component other than the thermoplastic resin may be contained in the resin layer (B2) included in the polarizer protective film of the present invention. As the resin component other than the thermoplastic resin, any appropriate resin component may be employed in such a range that the effect of the present invention is not adversely affected.

The resin layer (B2) included in the polarizer protective film of the present invention is a resin layer containing a thermoplastic resin as a main component, and is preferably a resin layer containing, as a main component, a thermoplastic resin other than a (meth) acrylic resin. Examples of the thermoplastic resin other than a (meth)acrylic resin are as described above.

As the UV absorber, preferred are/is a triazole-based UV absorber and/or a triazine-based UV absorber each having a weight loss of 10% or less by heating at 300° C. for 20 minutes. A measurement method of “weight loss by heating at 300° C. for 20 minutes” is described later. It is preferred that the weight losses/loss by heating at 300° C. for 20 minutes of the triazole-based UV absorber and/or the triazine-based UV absorber be as small as possible. The weight loss by heating at 300° C. for 20 minutes is preferably 9% or less, more preferably 8% or less, still more preferably 6% or less, and particularly preferably 5% or less. In the case of using the triazole-based UV absorber and/or the triazine-based UV absorber each having the weight loss by heating at 300° C. for 20 minutes of more than 10%, the polarizer protective film having sufficient UV-absorbing ability may not be obtained. A triazine-based UV absorber with a molecular weight of 400 or more is preferred. A triazole-based UV absorber with a molecular weight of 400 or more is preferred.

As the UV absorber, an appropriate UV absorber suitable for the present invention may be selected, for example. They may be used alone or in combination. Examples of the UV absorber include the UV absorbers described in JP 2001-72782 A and JP 2002-543265 A. Further, the melting point of the UV absorber is preferably 110° C. or higher and more preferably 120° C. or higher. When the melting point of the UV absorber is 130° C. or higher, the amount of the volatilization during heat-melting processing can be made smaller, which can make it difficult to cause deposition and aggregation at a forming outlet (such as an extrusion outlet) and contamination of a roll in the course of production of a film. In the polarizer protective film of the present invention, however, even if a UV absorber which easily volatilizes (has low melting point) is used, there is exhibited a remarkable effect that deposition and aggregation at a forming outlet (such as an extrusion outlet) and contamination of a roll in the course of production of a film are prevented from occurring.

The resin layer (A) contains a UV absorber at a ratio of, with respect to a resin component contained in the resin layer (A), 0.5 to 10 wt %, preferably 1 to 9 wt %, and more preferably 2 to 8 wt %. When the ratio of the UV absorber is less than 0.5 wt %, the UV-absorbing ability of the polarizer protective film may not be exhibited sufficiently. When the ratio of the UV absorber is more than 10 wt %, the heat resistance and the transparency of the polarizer protective film may deteriorate, and also the volatilization of the UV absorber may not be sufficiently suppressed by the resin layers (B1) and (B2). Note that the above ratio of the UV absorber is also applied to the ratio of the UV absorber in the material, which is to be formed into the resin layer (A) and used for forming the polarizer protective film of the present invention.

The resin layer (B1) may or may not contain a UV absorber. It is preferred that the resin layer (B1) contain a UV absorber. In this case, the resin layer (B1) contains a UV absorber at a ratio of, with respect to a resin component contained in the resin layer (B1), preferably more than 0 wt % to 2 wt % or less, more preferably 0.1 to 1.5 wt %, and still more preferably 0.2 to 1 wt %. When the ratio of the UV absorber is more than 2 wt %, the heat resistance and the transparency of the polarizer protective film may deteriorate, and also the volatilization of the UV absorber may not be sufficiently suppressed by the resin layer (B1). Note that the above ratio of the UV absorber is also applied to the ratio of the UV absorber in the material, which is to be formed into the resin layer (B1) and used for forming the polarizer protective film of the present invention.

The resin layer (B2) may or may not contain a UV absorber. It is preferred that the resin layer (B2) contain a UV absorber. In this case, the resin layer (B2) contains a UV absorber at a ratio of, with respect to a resin component contained in the resin layer (B2), preferably more than 0 wt % to 2 wt % or less, more preferably 0.1 to 1.5 wt %, and still more preferably 0.2 to 1 wt %. When the ratio of the UV absorber is more than 2 wt %, the heat resistance and the transparency of the polarizer protective film may deteriorate, and also the volatilization of the UV absorber may not be sufficiently suppressed by the resin layer (B2). Note that the above ratio of the UV absorber is also applied to the ratio of the UV absorber in the material, which is to be formed into the resin layer (B2) and used for forming the polarizer protective film of the present invention.

It is preferred that the content ratio of the UV absorber in the resin layer (B1) be smaller than the content ratio of the UV absorber in the resin layer (A). Further, in the case where the polarizer protective film also includes the resin layer (B2), it is preferred that the content ratio of the UV absorber in the resin layer (B1) and the content ratio of the UV absorber in the resin layer (B2) be each less than the content ratio of the UV absorber in the resin layer (A).

As the triazine-based UV absorber, a compound having a 1,3,5-triazine ring is preferably used, for example. Specifically, 2-(4,6-diphenyl-1,3,5-triazine-2-yl)-5-[(hexyl)oxy]-phenol and the like are exemplified.

Examples of the triazole-based UV absorber include 2,2′-methylenebis[4-(1,1,3,3-tetramethylbutyl)-6-(2H-benzotriazole-2-yl)phenol], 2-(3,5-di-tert-butyl-2-hydroxyphenyl)-5-chlorobenzotriazole, 2-(2H-benzotriazole-2-yl)-p-cresol, 2-(2H-benzotriazole-2-yl)-4,6-bis(1-methyl-1-phenylethyl)phenol, 2-benzotriazole-2-yl-4,6-di-tert-butylphenol, 2-[5-chloro(2H)-benzotriazole-2-yl]-4-methyl-6-(tert-butyl)phenol, 2-(2H-benzotriazole-2-yl)-4,6-di-tert-butylphenol, 2-(2H-benzotriazole-2-yl)-4-(1,1,3,3-tetramethylbutyl)phenol, 2-(2H-benzotriazole-2-yl)-4-methyl-6-(3,4,5,6-tetrahydrophthalimidylmethyl)phenol, a reaction product of methyl 3-(3-(2H-benzotriazole-2-yl)-5-tert-butyl-4-hydroxyphenyl)propionate and polyethyleneglycol 300, and 2-(2H-benzotriazole-2-yl)-6-(linear and side chain dodecyl)-4-methylphenol.

Examples of the commercially available product include “TINUVIN 1577” (manufactured by Ciba Specialty Chemicals Inc.) as a triazine-based UV absorber and “Adekastab LA-31” (manufactured by ADEKA Corporation) as a triazole-based UV absorber.

As a UV absorber having a weight loss of 10% or less in heating at 300° C. for 20 minutes, 2,2′-methylenebis[6-(2H-benzotriazole-2-yl)-4-(1,1,3,3-tetramethylbutyl)phenol] is exemplified. As a commercially available product, “Adekastab LA-31” (manufactured by ADEKA Corporation) as a triazole-based UV absorber is exemplified.

The polarizer protective film of the present invention preferably contains an antioxidant, and it is preferred that an antioxidant be contained in each of the resin layer (A), the resin layer (B1), and the resin layer (B2).

The resin layer (A) contains an antioxidant at a ratio of, with respect to a resin component contained in the resin layer (A), preferably 0.02 wt % or more, more preferably 0.02 to 5 wt %, still more preferably 0.05 to 3 wt %, and particularly preferably 0.1 to 2.5 wt %. When the amount of the antioxidant is less than 0.02 wt %, the decomposition of a resin component ((meth)acrylic resin in particular) may be accelerated. When the amount of the antioxidant is more than 5 wt %, the optical properties of the polarizer protective film to be obtained may deteriorate. Note that the above ratio of the antioxidant is also applied to the ratio of the antioxidant in the material, which is to be formed into the resin layer (A) and used for forming the polarizer protective film of the present invention.

The resin layer (B1) contains an antioxidant at a ratio of, with respect to a resin component contained in the resin layer (B1), preferably 0.02 wt % or more, more preferably 0.02 to 5 wt %, still more preferably 0.05 to 3 wt %, and particularly preferably 0.1 to 2.5 wt %. When the amount of the antioxidant is less than 0.02 wt %, the decomposition of a resin component ((meth)acrylic resin in particular) may be accelerated. When the amount of the antioxidant is more than 5 wt %, the optical properties of the polarizer protective film to be obtained may deteriorate. Note that the above ratio of the antioxidant is also applied to the ratio of the antioxidant in the material, which is to be formed into the resin layer (B1) and used for forming the polarizer protective film of the present invention.

The resin layer (B2) contains an antioxidant at a ratio of, with respect to a resin component contained in the resin layer (B2), preferably 0.02 wt % or more, more preferably 0.02 to 5 wt %, still more preferably 0.05 to 3 wt %, and particularly preferably 0.1 to 2.5 wt %. When the amount of the antioxidant is less than 0.02 wt %, the decomposition of a resin component ((meth)acrylic resin in particular) may be accelerated. When the amount of the antioxidant is more than 5 wt %, the optical properties of the polarizer protective film to be obtained may deteriorate. Note that the above ratio of the antioxidant is also applied to the ratio of the antioxidant in the material, which is to be formed into the resin layer (B2) and used for forming the polarizer protective film of the present invention.

In order to express the effects of the present invention additionally, it is preferred that the antioxidant contain a phenol-based antioxidant. As the phenol-based antioxidant, any appropriate phenol-based antioxidant may be employed. Examples thereof include n-octadecyl=3-(3,5-di-t-butyl-4-hydroxyphenyl)-propionate, n-octadecyl=3-(3,5-di-t-butyl-4-hydroxyphenyl)-acetate, n-octadecyl=3,5-di-t-butyl-4-hydroxybenzoate, n-hexyl=3,5-di-t-butyl-4-hydroxyphenylbenzoate, n-dodecyl=3,5-di-t-butyl-4-hydroxyphenylbenzoate, neo-dodecyl=3-(3,5-di-t-butyl-4-hydroxyphenyl)propionate, dodecyl=β (3,5-di-t-butyl-4-hydroxyphenyl)propionate, ethyl=α-(4-hydroxy-3,5-di-t-butylphenyl)isobutylate, octadecyl=α-(4-hydroxy-3,5-di-t-butylphenyl)isobutylate, octadecyl=α-(4-hydroxy-3,5-di-t-butyl-4-hydroxyphenyl)propionate, 2-(n-octylthio)ethyl=3,5-di-t-butyl-4-hydroxy-benzoate, 2-(n-octylthio)ethyl=3,5-di-t-butyl-4-hydroxy-phenylacetate, 2-(n-octadecylthio)ethyl=3,5-di-t-butyl-4-hydroxyphenylacetate, 2-(n-octadecylthio)ethyl=3,5-di-t-butyl-4-hydroxybenzoate, 2-(2-hydroxyethylthio)ethyl=3,5-di-t-butyl-4-hydroxybenzoate, diethylglycol=bis(3,5-di-t-butyl-4-hydroxy-phenyl)propionate, 2-(n-octadecylthio)ethyl=3-(3,5-di-t-butyl-4-hydroxyphenyl)propionate, stearamide-N,N-bis-[ethylene=3-(3,5-di-t-butyl-4-hydroxyphenyl)propionate], n-butylimino-N,N-bis-[ethylene=3-(3,5-di-t-butyl-4-hydroxyphenyl)propionate], 2-(2-stearoyloxyethylthio)ethyl=3,5-di-t-butyl-4-hydroxybenzoate, 2-(2-stearoyloxyethylthio)ethyl=7-(3-methyl-5-t-butyl-4-hydroxyphenyl)heptanoate, 1,2-propyleneglycol=bis[3-(3,5-di-t-butyl-4-hydroxyphenyl)propionate], ethylglycol=bis[3-(3,5-di-t-butyl-4-hydroxyphenyl)propionate], neopentylglycol=bis[3-(3,5-di-t-butyl-4-hydroxyphenyl)propionate], ethyleneglycol=bis(3,5-di-t-butyl-4-hydroxyphenylacetate), glycerin-1-n-octadecanoate-2,3-bis-(3,5-di-t-butyl-4-hydroxyphenylacetate), pentaerythritol-tetrakis-[3-(3′,5′-di-t-butyl-4′-hydroxyphenyl)propionate], 1,1,1-trimethylolethane-tris-[3-(3,5-di-t-butyl-4-hydroxyphenyl)propionate], sorbitol hexa-[3-(3,5-di-t-butyl-4-hydroxyphenyl)propionate], 2-hydroxyethyl=7-(3-methyl-5-t-butyl-4-hydroxyphenyl)propionate, 2-stearoyloxyethyl=7-(3-methyl-5-t-butyl-4-hydroxyphenyl)heptanoate, 1,6-n-hexanediol-bis[(3′,5′-di-t-butyl-4-hydroxyphenyl)propionate], pentaerythritol-tetrakis(3,5-di-t-butyl-4-hydroxyhydrocinnamate), and 3,9-bis[1,1-dimethyl-2-[β-(3-t-butyl-4-hydroxy-5-methylphenyl) propionyloxy]ethyl]2,4,8,10-tetraoxaspiro[5,5]-undecane. As the antioxidant having weight loss of 10% or less in heating at 300° C. for 20 minutes, there are exemplified pentaerythritol-tetrakis-[3-(3′,5′-di-t-butyl-4′-hydroxyphenyl)propionate], and 3,9-bis[1,1-dimethyl-2-[β-(3-t-butyl-4-hydroxy-5-methylphenyl) propionyloxy]ethyl]2,4,8,10-tetraoxaspiro[5,5]-undecane.

In order to express the effects of the present invention additionally, it is more preferred that, in each of the resin layer (A), the resin layer (B1), and the resin layer (B2), the antioxidant contain 0.01 wt % or more of a phenol-based antioxidant and 0.01 wt % or more of a thioether-based antioxidant with respect to the resin component in each layer. It is much more preferred that the antioxidant contain 0.025 wt % or more of the phenol-based antioxidant and 0.025 wt % or more of the thioether-based antioxidant, and it is particularly preferred that the antioxidant contain 0.05 wt % or more of the phenol-based antioxidant and 0.05 wt % or more of the thioether-based antioxidant. Note that the above ratio of the antioxidant is also applied to the ratios of the antioxidants in the materials, which are to be formed into the resin layer (A), the resin layer (B1), and the resin layer (B2) and used for forming the polarizer protective film of the present invention.

As the thioether-based antioxidant, any appropriate thioether-based antioxidant can be adopted. Examples thereof include pentaerythrityltetrakis(3-laurylthiopropionate), dilauryl-3,3′-thiodipropionate, dimyristyl-3,3′-thiodipropionate, and distearyl-3,3′-thiodipropionate. An example of the thioether-based antioxidant whose weight loss in heating at 300° C. for 20 minutes is 10% or less includes pentaerythrityltetrakis(3-laurylthiopropionate).

In order to express the effects of the present invention additionally, it is preferred that, in each of the resin layer (A), the resin layer (B1), and the resin layer (B2), the antioxidant contains 0.01 wt % or more of a phenol-based antioxidant and 0.01 wt % or more of a phosphorus-based antioxidant with respect to the resin component in each layer. It is more preferred that the antioxidant contain 0.1 wt % or more of the phenol-based antioxidant and 0.1 wt % or more of the phosphorus-based antioxidant, and it is particularly preferred that the antioxidant contain 0.5 wt % or more of the phenol-based antioxidant and 0.5 wt % or more of the phosphorus-based antioxidant. Note that the above ratio of the antioxidant is also applied to the ratios of the antioxidants in the materials, which are to be formed into the resin layer (A), the resin layer (B1), and the resin layer (B2) and used for forming the polarizer protective film of the present invention.

As the phosphorus-based antioxidant, any appropriate phosphorus-based antioxidant may be employed. Examples thereof include tris(2,4-di-t-butylphenyl)phosphite, 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine, diphenyltridecylphosphite, triphenylphosphite, 2,2-methylenebis(4,6-di-t-butylphenyl)octylphosphite, bis(2,6-di-t-butyl-4-methylphenyl)pentaerythritol diphosphite, distearyl pentaerythritol diphosphite, and cyclic neopentanetetraylbis(2,6-di-t-butyl-4-methylphenyl)phosphite. As the antioxidant having weight loss of 10% or less in heating at 300° C. for 20 minutes, there is exemplified cyclic neopentanetetraylbis(2,6-di-t-butyl-4-methylphenyl)phosphite.

The resin layer (A), the resin layer (B1), and the resin layer (B2) may each include, in addition to the thermoplastic resin (the (meth)acrylic resin and thermoplastic resin other than a (meth) acrylic resin), the UV absorber, and the antioxidant, general compounding agents such as a stabilizer, a lubricant, a processing aid, a plasticizer, a impact-resistant aid, a retardation reducing agent, a flatting agent, an antimicrobial agent, and a fungicide, for example.

The polarizer protective film of the present invention preferably has a high light transmittance, and preferably has a low in-plane retardation Δnd a low thickness direction retardation Rth. The in-plane retardation Δnd can be obtained by Δnd=(nx−ny)×d. The thickness direction retardation Rth can be obtained by Rth=(nx−nz)×d. Herein, nx and ny are refractive indices in a plane in a slow axis direction and a fast axis direction, respectively, and nz is a thickness direction refractive index. The slow axis direction refers to a direction in which an in-plane refractive index becomes maximum.

The light transmittance at 380 nm in the thickness of 50 μm of the polarizer protective film of the present invention is preferably 10% or less, more preferably 9% or less, still more preferably 8% or less, still more preferably 7% or less, particularly preferably 6% or less, and most preferably 5% or less. When the light transmittance at 380 nm in the thickness of 50 μm of the polarizer protective film of the present invention exceeds 10%, sufficient UV-absorbing ability may not be exhibited.

Note that a polarizer protective film sample is cut into a square 3-cm on a side and the light transmittance at 380 nm may be measured with “UV-VIS-NIR-SPECTROMETER UV3150” manufactured by Shimadzu Corporation.

In the polarizer protective film of the present invention, YI in a thickness of 50 μm is preferably 1.27 or less, more preferably 1.25 or less, still more preferably 1.23 or less, and particularly preferably 1.20 or less. When the YI exceeds 1.3, excellent optical transparency may not be exhibited.

Note that the YI can be obtained, for example, by the following expression based on tristimulus values (X, Y, Z) of a color obtained by measurement, using a high-speed integrating-sphere spectral transmittance meter (DOT-3C (trade name), manufactured by Murakami Color Research Laboratory Instruments).

YI=[(1.28X−1.06Z)/Y]×100

A b-value (scale of a hue in accordance with a Hunter-color system) in a thickness of 50 μm of the polarizer protective film of the present invention is preferably less than 1.5, and more preferably 1.0 or less. In the case where the b-value is 1.5 or more, excellent optical transparency may not be exhibited due to the coloring of a film.

Note that the b-value can be obtained, for example, by cutting a polarizer protective film sample into pieces each having 3 cm per side and measuring the hue thereof using the high-speed integrating-sphere spectral transmittance meter (DOT-3C (trade name), manufactured by Murakami Color Research Laboratory Instruments). The hue can be evaluated based on the b-value in accordance with the Hunter-color system.

In the polarizer protective film of the present invention, an in-plane retardation Δnd is preferably 200 nm or less and more preferably 150 nm or less. When the in-plane retardation Δnd exceeds 200 nm, the effects of the present invention, in particular, excellent optical properties may not be exhibited. A thickness direction retardation Rth is preferably 150 nm or less and more preferably 100 nm or less. When the thickness direction retardation Rth exceeds nm, excellent optical properties may not be exhibited. When the polarizer protective film of the present invention is placed between the polarizer and the liquid crystal cell, the retardation is preferably within the above range.

In the polarizer protective film of the present invention, moisture permeability is preferably 100 g/m²·24 hr or less and more preferably 65 g/m²·24 hr or less. When the moisture permeability exceeds 100 g/m²·24 hr, moisture resistance may be degraded.

The polarizer protective film of the present invention also preferably has excellent mechanical strength. The tensile strength in an MD direction is preferably 65 N/mm² or more, more preferably 70 N/mm² or more, still more preferably 75 N/mm² or more, and particularly preferably 80 N/mm² or more. The tensile strength in a TD direction is preferably 45 N/mm² or more, more preferably 50 N/mm² or more, still more preferably 55N/mm² or more, and particularly preferably 60N/mm² or more. The tensile elongation in an MD direction is preferably 6.5% or more, more preferably 7.0% or more, still more preferably 7.5% or more, and particularly preferably 8.0% or more. The tensile elongation in a TD direction is preferably 5.0% or more, more preferably 5.5% or more, still more preferably 6.0% or more, and particularly preferably 6.5% or more. In the case where the tensile strength or the tensile elongation is out of the above ranges, the excellent mechanical strength may not be exhibited.

The haze representing optical transparency of the polarizer protective film of the present invention is preferably as low as possible, and is preferably 5% or less, more preferably 3% or less, and still more preferably 1.5% or less, and particularly preferably 1% or less. When the haze is 5% or less, the film can be visually provided with satisfactory clear feeling. When the haze is 1.5% or less, even if the polarizer protective film is used as a lighting member such as a window, both visibility and lighting property can be obtained, and even if the polarizer protective film is used as a front plate of a display apparatus, display contents can be visually recognized satisfactorily. Thus, the polarizer protective film has a high industrial use value.

The polarizer protective film of the present invention has, in each of the layers, a delamination strength of preferably 1.2 N/25 mm or more, more preferably 2.0 N/25 mm or more, still more preferably 2.5 N/25 mm or more, and still more preferably 2.9 N/25 mm or more. Any appropriate value may be adopted for the upper limit of the delamination strength. For example, the upper limit is 50 N/25 mm or less. In the case where the delamination strength is less than 1.2 N/25 mm, peeling may occur in the case of performing, for example, a stretching treatment.

The polarizer protective film of the present invention has, in each of the layers, a melt flow rate measured at a temperature of 240° C. and a load of 10 kgf of preferably 1 to 20 g/10 min, more preferably 3 to 19 g/10 min, still more preferably 5 to 18 g/10 min, and particularly preferably 8 to 17 g/10 min.

The polarizer protective film of the present invention may have one or more layers other than the resin layer (B1), the resin layer (A), and the resin layer (B2). The total number of layers that the polarizer protective film of the present invention has is 2 or more, preferably 2 to 10, and more preferably 3 to 5.

The polarizer protective film of the present invention is preferably a film which is produced by subjecting resins for forming respective layers (that is, at least the resin layer (B1) and the resin layer (A)) to coextrusion molding. There can be produced, with good productivity, a polarizer protective film having a good adhesive property between the layers by coextrusion molding.

As materials for forming respective layers (that is, at least the resin layer (B1) and the resin layer (A)) to be subjected to coextrusion molding, a mixture in which the above-mentioned components of the respective layers are mixed by any appropriate method may be used. Note that, when a UV absorber, an antioxidant, or another additive and the like is blended to the resin component, it is preferred to perform biaxial kneading using direct adding or a master batch method. As for a kneading method, the kneading is preferably performed by using TEM manufactured by Toshiba Machine Co., Ltd. or the like and preferably performing temperature setting in such a manner that the temperature of a resin is in a range of 230 to 270° C. When the temperature becomes too high, the decomposition of a (meth) acrylic resin may be easily accelerated. Further, heating is preferably performed, if required.

In the coextrusion molding, it is not necessary to dry and scatter a solvent in an adhesive used during processing, e.g., an organic solvent in an adhesive for dry lamination or to perform a solvent drying step, and thus the coextrusion molding is excellent in productivity. Specifically, there is exemplified a method of forming a laminate film (for example, a feed block-type method or a manifold-type method) by supplying a resin forming the resin layer (A) to an extruder, a resin forming the resin layer (B1) to another extruder, and a resin forming the resin layer (B2) to the other extruder of three extruders connected to a T-die, so that the resin layer (B1) and the resin layer (B2) come in direct contact with both sides of the resin layer (A), followed by melt kneading, extrusion, water-cooling, and withdrawing. The extruder to be used in the melting of each resin layer may be of a monoaxial or biaxial screw type.

The forming temperature can be set appropriately, when the glass transition temperature of a resin composition is referred to as Tg (° C.), (Tg+80)° C. to (Tg+180)° C. is preferred, and (Tg+100)° C. to (Tg+160)° C. is more preferred. When the forming temperature is too low, a resin may not be formed due to lack of flowability. When the forming temperature is too high, the viscosity of a resin becomes low, which may cause a problem in production stability such as non-uniform thickness of a formed product. In the case of a multilayer molded product, it is preferred to set the glass transition temperature of the resin to a higher temperature.

According to the coextrusion molding, processes of drying and scattering a solvent in an adhesive is not necessary, because the film is formed not via an adhesive layer, and thus, the film is excellent in productivity. Further, two kinds of resins are directly in contact with each other, and hence, the deterioration in durability which is attributed to the adhesive layer, such as the deterioration in adhesive strength or the deterioration in optical properties due to degradation of the adhesive layer, can be suppressed.

Regarding the optical properties of a polarizer protective film, the retardation in front and thickness directions poses a problem. Therefore, the resin for forming the film (that is, the resin for forming the resin layer (B1), the resin layer (A), or the resin layer (B2)) may contain a retardation reducing agent. As the retardation reducing agent, for example, a styrene-containing polymer such as an acrylonitrile-styrene block copolymer and a copolymer of an acrylonitrile-styrene block copolymer are preferred. The adding amount of the retardation reducing agent is preferably 30 wt % or less, more preferably 25 wt % or less, and still more preferably 20 wt % or less with respect to the resin component in each layer. In a case where the retardation reducing agent is added in an amount exceeding this range, visible light may be scattered, and transparency may be impaired, with the result that the polarizer protective film may lack characteristics thereof.

The polarizer protective film of the present invention can be used by being laminated on another base material. For example, the polarizer protective film can also be formed to be laminated on a base material made of glass, a polyolefin resin, an ethylene vinylidene copolymer to be a high barrier layer, or a polyester and the like by multi-layer extrusion molding or multi-layer inflation molding including an adhesive resin layer. In the case where heat fusion property is high, an adhesion layer may be omitted.

The polarizer protective film of the present invention may be stretched by longitudinal stretching and/or lateral stretching.

The stretching may be stretching only by longitudinal stretching (free-end uniaxial stretching) or may be stretching only by lateral stretching (fixed-end uniaxial stretching). However, it is preferred that the stretching is sequential stretching or simultaneous biaxial stretching with a longitudinal stretching ratio of 1.1 to 3.0 times and a lateral stretching ratio of 1.1 to 3.0 times. In the stretching only by longitudinal stretching (free-end uniaxial stretching) or stretching only by lateral stretching (fixed-end uniaxial stretching), the film strength increases only in the stretching direction and the strength does not increase in a direction orthogonal to the stretching direction, with the result that sufficient film strength may not be obtained in the whole film. The longitudinal stretching ratio is preferably 1.2 to 2.5 times and more preferably 1.3 to 2.0 times. The lateral stretching ratio is more preferably 1.2 to 2.5 times and still more preferably 1.4 to 2.5 times. In the case where the longitudinal stretching ratio and the lateral stretching ratio are less than 1.1 times, the stretching ratio is too low, with the result that effects of the stretching may be hardly exhibited. When the longitudinal stretching ratio and the lateral stretching ratio exceed 3.0 times, stretching breakage is likely to occur due to the smoothness of a film end face.

The stretching temperature is preferably Tg to (Tg+30° C.) of a film to be stretched. When the stretching temperature is lower than Tg, the film may be broken. When the stretching temperature exceeds (Tg+30° C.), the film may start melting and feeding of the film becomes difficult.

The polarizer protective film of the present invention is stretched by longitudinal stretching and/or lateral stretching, whereby the polarizer protective film has excellent optical properties and mechanical strength, and has enhanced productivity and rework property. The thickness of the stretched polarizer protective film is preferably 10 to 80 μm, and more preferably 15 to 60 μm.

The polarizer protective film of the present invention can be used by being laminated onto, for example, a lighting member for construction, such as a window and a carport roof member, a lighting member for a vehicle, such as a window, a lighting member for agriculture, such as a greenhouse, an illumination member, a display member such as a front filter, or the like, in addition to the application to the protection of a polarizer. Further, the polarizer protective film of the present invention can also be used by being laminated onto a package of consumer electronics, an interior member in a vehicle, a construction material for an interior, a wall paper, a decorative laminate, a hallway door, a window frame, a foot stall, and the like, which are covered with a (meth) acrylic resin film conventionally.

### [Polarizing Plate]

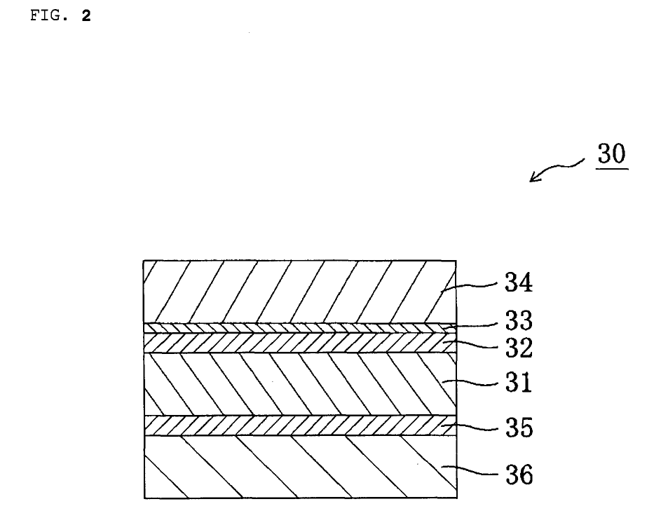

The polarizing plate of the present invention includes a polarizer formed of a polyvinyl alcohol-based resin and a polarizer protective film of the present invention. In one preferred embodiment of the polarizing plate of the present invention, as shown in FIG. 2, one surface of a polarizer 31 is bonded to a polarizer protective film 34 of the present invention via an adhesive layer 32 and an easy adhesion layer 33, and the other surface of the polarizer 31 is bonded to the polarizer protective film 36 via the adhesive layer 35. The polarizer protective film 36 may be the polarizer protective film of the present invention, or any appropriate polarizer protective film. Further, an easy adhesion layer may be present between the adhesive layer 35 and the polarizer protective film 36.

As the polarizer formed of a polyvinyl alcohol-based resin, the film obtained by coloring a polyvinyl alcohol-based resin film with a dichromatic substance (typically, iodine or a dichromatic dye) and uniaxially stretching is used. The polymerization degree of the polyvinyl alcohol-based resin for forming the polyvinyl alcohol-based resin film is preferably 100 to 5,000, and more preferably 1,400 to 4,000. The polyvinyl alcohol-based resin film for forming the polarizer may be formed by any appropriate method (such as a flow casting method involving film formation through flow casting of a solution containing a resin dissolved in water or an organic solvent, a casting method, or an extrusion method). The thickness of the polarizer may be appropriately set in accordance with the purpose and application of LCD employing the polarizing plate, but is typically 5 to 80 μm.

For producing a polarizer, any appropriate method may be employed in accordance with the purpose, materials to be used, conditions, and the like. Typically, employed is a method in which the polyvinyl alcohol-based resin film is subjected to a series of production steps including swelling, coloring, cross-linking, stretching, water washing, and drying steps. In each of the treatment steps excluding the drying step, the polyvinyl alcohol-based resin film is immersed in a bath containing a solution to be used in each step. The order, number of times, and absence or presence of swelling, coloring, cross-linking, stretching, water washing, and drying steps may be appropriately set in accordance with the purpose, materials to be used, conditions, and the like. For example, several treatments may be conducted at the same time in one step, or specific treatments may be omitted. More specifically, stretching treatment, for example, may be conducted after coloring treatment, before coloring treatment, or at the same time as swelling treatment, coloring treatment, and cross-linking treatment. Further, for example, cross-linking treatment can be preferably conducted before and after stretching treatment. Further, for example, water washing treatment may be conducted after each treatment or only after specific treatments. A conventional method can be adopted for each of the respective treatments of swelling, coloring, cross-linking, stretching, water washing, and drying.

The polarizing plate of the present invention has an adhesive layer formed between the polarizer protective film and the polarizer. That is, the polarizer is bonded to the polarizer protective film of the present invention via an adhesive layer.

In the present invention, the polarizer protective film and the polarizer are bonded to each other via an adhesive layer formed of an adhesive. The adhesive layer is preferably a layer formed of a polyvinyl alcohol-based adhesive. The polyvinyl alcohol-based adhesive contains a polyvinyl alcohol-based resin and a cross-linking agent.

Examples of the polyvinyl alcohol-based resin include, without particular limitation: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft polymer, phosphate, or the like. Examples of the monomer include: unsaturated carboxylic acids such as maleic (anhydride), fumaric acid, crotonic acid, itaconic acid, and (meth)acrylic acid and esters thereof; α-olefins such as ethylene and propylene; (sodium) (meth)allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. They may be used alone or in combination.

The polyvinyl alcohol-based resin has, from the viewpoint of an adhesive property, an average polymerization degree of preferably 100 to 3,000 and more preferably 500 to 3,000, and an average saponification degree of preferably 85 to 100 mol % and more preferably 90 to 100 mol %.

A polyvinyl alcohol-based resin having an acetoacetyl group may be used as the polyvinyl alcohol-based resin. The polyvinyl alcohol-based resin having an acetoacetyl group is a highly reactive functional group and is preferred from the viewpoint of improving durability of a polarizing plate.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, in advance, and adding diketene thereto. Another example of the known method is a method involving directly bringing diketene gas or a liquid diketene into contact with polyvinyl alcohol.

A degree of acetoacetyl modification of the polyvinyl alcohol-based resin having an acetoacetyl group is not particularly limited as long as it is 0.1 mol % or more. A degree of acetoacetyl group modification of less than 0.1 mol % provides insufficient water resistance with the adhesive layer and is inappropriate. The degree of acetoacetyl modification is preferably 0.1 to 40 mol % and more preferably 1 to 20 mol %. A degree of acetoacetyl group modification of more than 40 mol % decreases the number of reaction sites with a cross-linking agent and provides a small effect of improving the water resistance. The degree of acetoacetyl group modification is a value measured by NMR.

As the cross-linking agent, the one used for a polyvinyl alcohol-based adhesive can be used without particular limitation. A compound having at least two functional groups each having reactivity with a polyvinyl alcohol-based resin can be used as the cross-linking agent. Examples of the compound include: alkylene diamines having an alkylene group and two amino groups such as ethylene diamine, triethylene diamine, and hexamethylene dimamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethane)triisocyanate, isophorone diisocyanate, and ketoxime blocked compounds or phenol blocked compounds thereof; epoxies such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylol urea, methylolmelamine, alkylated methylol urea, alkylated methylol melamine, acetoguanamine, or benzoguanamine; and salts of divalent or trivalent metals such as sodium, potassium, magnesium, calcium, aluminum, iron, and nickel and oxides thereof. A melamine-based cross-linking agent is preferred as the cross-linking agent, and methylolmelamine is particularly preferred.

A mixing amount of the cross-linking agent is preferably 0.1 to 35 parts by weight and more preferably 10 to 25 parts by weight with respect to 100 parts by weight of the polyvinyl alcohol-based resin. Meanwhile, for further improving the durability, the cross-linking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the cross-linking agent is preferably used in an amount of more than 30 parts by weight. The cross-linking agent is mixed within a range of more than 30 parts by weight and 46 parts by weight or less, to thereby improve the water resistance.

Note that the polyvinyl alcohol-based adhesive can also contain a coupling agent such as a silane coupling agent or a titanium coupling agent, various kinds of tackifiers, a UV absorber, an antioxidant, a stabilizer such as a heat-resistant stabilizer or a hydrolysis-resistant stabilizer.

In the polarizer protective film of the present invention, the surface which comes into contact with a polarizer can be subjected to easy adhesion processing for the purpose of enhancing the adhesive property. Examples of the easy adhesion processing include surface treatments such as corona treatment, plasma treatment, low-pressure UV treatment, and saponification, and the formation of an easy adhesion layer. They may be used in combination. Of those, the corona treatment, the formation of an easy adhesion layer, and a combination thereof are preferred.

The adhesive layer is formed by applying the adhesive on one side or both sides of a polarizer protective film, and on one side or both sides of a polarizer. After the polarizer protective film and the polarizer are attached to each other, a drying step is performed, to thereby form an adhesive layer made of an applied dry layer. After the adhesive layer is formed, the polarizer and the polarizer protective film may also be attached to each other. The polarizer and the polarizer protective film are attached to each other with a roll laminator or the like. The heat-drying temperature and the drying time are appropriately determined depending upon the kind of an adhesive.

Too large thickness of the adhesive layer after drying is not preferred in view of the adhesive property of the polarizer protective film. Therefore, the thickness of the adhesive layer is preferably 0.01 to 10 μm, and more preferably 0.03 to 5 μm.

The attachment of a polarizer protective film to a polarizer can be performed by bonding both surfaces of the polarizer to one side of the polarizer protective film.

Further, the attachment of a polarizer to a polarizer protective film can be performed by bonding one surface of the polarizer to one side of the polarizer protective film and attaching a cellulose-based resin film to the other surface of the polarizer.

The cellulose-based resin is not particularly limited. However, triacetyl cellulose is preferred in terms of transparency and an adhesive property. The thickness of the cellulose-based resin is preferably 30 to 100 μm and more preferably 40 to 80 μm. When the thickness is smaller than 30 μm, the film strength decreases to degrade workability, and when the thickness is larger than 100 μm, the light transmittance decreases remarkably in terms of durability.

The polarizing plate according to the present invention may have a pressure-sensitive adhesive layer on at least one side of resin layers (such a polarizing plate may be referred to as polarizing plate of a pressure-sensitive adhesion type). As a particularly preferred embodiment, a pressure-sensitive adhesive layer for bonding with other members such as another optical film and a liquid crystal cell can be provided to an opposite side of the polarizer protective film to which the polarizer is bonded.

The pressure-sensitive adhesive forming the pressure-sensitive adhesive layer is not particularly limited. However, for example, a pressure-sensitive adhesive containing as a base polymer an acrylic polymer, a silicone-based polymer, polyester, polyurethane, polyamide, polyether, a fluorine or rubber-based polymer can be appropriately selected to be used. In particular, a pressure-sensitive adhesive such as an acrylic pressure-sensitive adhesive is preferably used, which is excellent in optical transparency, exhibits appropriate wettability and pressure-sensitive adhesion properties of a cohesive property and an adhesive property, and is excellent in weather resistance and heat resistance. In particular, an acrylic pressure-sensitive adhesive made of an acrylic polymer having 4 to 12 carbon atoms is preferred.

In addition to the above, in terms of the prevention of a foaming phenomenon and a peeling phenomenon caused by moisture absorption, the prevention of a degradation in optical properties and bending of a liquid crystal cell caused by thermal expansion difference or the like, and the formation property of a liquid crystal display apparatus which is of high quality and has excellent durability, a pressure-sensitive adhesive layer having a low moisture absorbing ratio and excellent heat resistance is preferred.

The pressure-sensitive adhesive layer may contain, for example, resins of a natural substance or a synthetic substance, in particular, additives to be added to the pressure-sensitive adhesive layer including a tackifying resin, a filler such as glass fibers, glass beads, metal powder, or other inorganic powders, a pigment, a colorant, and an antioxidant.

Further, a pressure-sensitive adhesive layer that contains fine particles and exhibits a light diffusion property or the like may be used.

The pressure-sensitive adhesive layer can be provided by any appropriate method. Examples thereof include a method involving preparing a pressure-sensitive adhesive solution in an amount of about 10 to 40 wt % in which a base polymer or a composition thereof is dissolved or dispersed in any appropriate single solvent such as toluene or ethyl acetate or a solvent made of a mixture, and directly providing the pressure-sensitive adhesive solution onto a polarizing plate or an optical film by any appropriate development method such as a flow casting method or a coating method, or a method involving forming a pressure-sensitive adhesive layer on a separator according to the above, and moving the pressure-sensitive adhesive layer to the polarizer protective film surface.

The pressure-sensitive adhesive layer may also be provided on one surface or both surfaces of a polarizing plate as superimposed layers of different compositions, different kinds, or the like. In the case of providing the pressure-sensitive adhesive layer on both surfaces of the polarizing plate, pressure-sensitive adhesive layers on front and reverse surfaces of the polarizing plate can have different compositions, kinds, thicknesses, and the like.

The thickness of the pressure-sensitive adhesive layer can be determined appropriately in accordance with the use purpose and the adhesive strength, and is preferably 1 to 40 μm, more preferably 5 to 30 μm, and particularly preferably 10 to 25 μm. When the thickness of the pressure-sensitive adhesive layer is smaller than 1 μm, durability of the layer degrades. When the thickness of the pressure-sensitive adhesive layer is larger than 40 μm, lifting and peeling are likely to occur due to foaming or the like, resulting in an unsatisfactory external appearance.

In order to enhance the adhesiveness between the polarizer protective film and the pressure-sensitive adhesive layer, an anchor layer can also be provided therebetween.

As the anchor layer, preferably, an anchor layer selected from polyurethane, polyester, and polymers containing amino groups in molecules is used, and in particular, polymers containing amino groups in molecules are preferably used. In the polymer containing an amino group in molecules, an amino group in the molecules reacts with a carboxyl group in the pressure-sensitive adhesive or a polar group in a conductive polymer, or exhibits an interaction such as an ion interaction, so satisfactory adhesiveness is ensured.

Examples of the polymers containing amino groups in molecules include polyethyleneimine, polyallylamine, polyvinylamine, polyvinylpyridine, polyvinylpyrrolidine, and a polymer of an amino group-containing monomer such as dimethylaminoethyl acrylate shown in the copolymerized monomer of the acrylic pressure-sensitive adhesive.

In order to provide the anchor layer with an antistatic property, an antistatic agent can also be added.

Note that, in the present invention, each layer of apolarizer, a polarizer protective film, and the like forming the polarizing plate, and the pressure-sensitive adhesive layer may be provided with a UV-absorbing ability, for example, by the treatment with a UV absorber such as a salicylate-based compound, a benzophenol-based compound, benzotriazol-based compound, a cyanoacrylate-based compound, and a nickel complex salt-based compound.

The polarizing plate of the present invention may be provided on one of a viewer side and a backlight side of a liquid crystal cell or on both sides thereof without particular limitation.

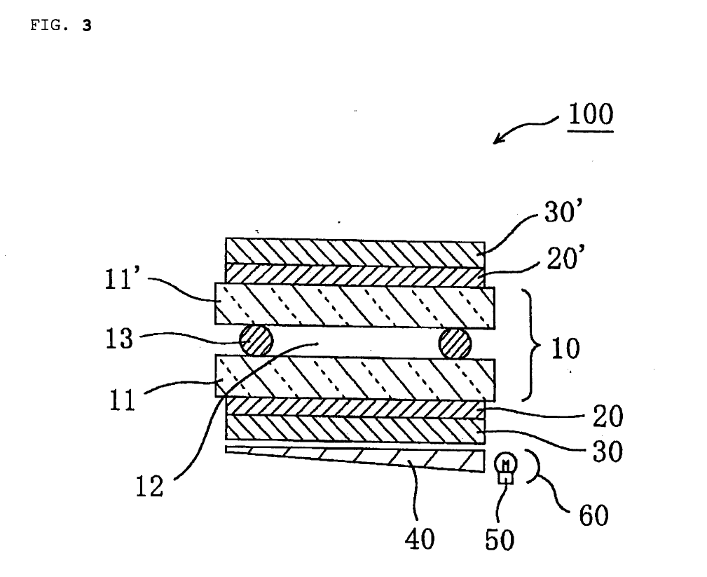

Next, an image display apparatus of the present invention is described. The image display apparatus of the present invention includes at least one polarizing plate of the present invention. Herein, as one example, a liquid crystal display apparatus is described. However, it is needless to say that the present invention is applicable to any display apparatus requiring a polarizing plate. Specific examples of the image display apparatus to which the polarizing plate of the present invention is applicable include a self-emitting display apparatus such as an electroluminescence (EL) display, a plasma display (PD), and a field emission display (FED). FIG. 3 is a schematic cross-sectional view of a liquid crystal display apparatus according to a preferred embodiment of the present invention. In the illustrated example, a transmission-type liquid crystal display apparatus is described. However, it is needless to say that the present invention is also applicable to a reflection-type liquid crystal display apparatus or the like.

A liquid crystal display apparatus 100 includes a liquid crystal cell 10, retardation films 20 and 20′ placed so as to interpose the liquid crystal cell 10 therebetween, polarizing plates 30 and 30′ placed on outer sides of the retardation films 20 and 20′, a light guide plate 40, a light source 50, and a reflector 60. The polarizing plates 30 and 30′ are placed so that polarization axes thereof are perpendicular to each other. The liquid crystal cell 10 includes a pair of glass substrates 11 and 11′ and a liquid crystal layer 12 as a display medium placed between the substrates. One glass substrate 11 is provided with a switching element (typically, TFT) for controlling the electrooptical properties of liquid crystals, a scanning line for providing a gate signal to the switching element, and a signal line for providing a source signal to the switching element (all of them are not shown). The other glass substrate 11′ is provided with a color layer forming a color filter and a shielding layer (black matrix layer) (both of them are not shown). A distance (cell gap) between the glass substrates 11 and 11′ is controlled by a spacer 13. In the liquid crystal display apparatus of the present invention, the polarizing plate of the present invention described above is employed as at least one of the polarizing plates 30 and 30′.

For example, in the case of the liquid crystal display apparatus 100 employing a TN mode, liquid crystal molecules of the liquid crystal layer 12 are aligned in a state with respective polarization axes being shifted by 90° during no voltage application. In such a state, incident light including light in one direction transmitted through the polarizing plate is twisted 90° by the liquid crystal molecules. As described above, the polarizing plates are arranged such that the respective polarization axes are perpendicular to each other, and thus light (polarized light) reaching the other polarizing plate transmits through the polarizing plate. Thus, during no voltage application, the liquid crystal display apparatus 100 provides a white display (normally white mode). Meanwhile, in the case where a voltage is applied onto the liquid crystal display apparatus 100, alignment of the liquid crystal molecules in the liquid crystal layer 12 changes. As a result, the light (polarized light) reaching the other polarizing plate cannot transmit through the polarizing plate, and a black display is provided. Displays are switched as described above by pixel by using the active element, to thereby form an image.

### EXAMPLES

Hereinafter, the present invention is described specifically with reference to examples, but the present invention is not limited to the examples. Unless otherwise noted, “parts” and “%” in the examples refer to “parts by weight” and “wt %”, respectively. Evaluations were performed as follows.

### <Measurement of Thickness>

In the case where a thickness was less than 10 μm, the thickness was measured by using a spectrophotometer for a thin film, “Multi Channel Photo Detector MCPD-2000” (trade name), manufactured by Otsuka Electronics Co., Ltd. In the case where a thickness was 10 μm or more, the thickness was measured by using a digital micrometer “KC-351C type” manufactured by Anritsu Corporation.

### <Weight Loss in Heating at 300° C. for 20 Minutes>

The weight loss in heating at 300° C. for 20 minutes was evaluated based on the weight loss rate in the case of heating at 300° C. for 20 minutes in a nitrogen stream. The weight loss was measured in a nitrogen stream by a thermogravimetric analysis apparatus (TG/DTA6200 manufactured by Seiko Instruments Inc.) using about to 10 mg of a sample. The sample was raised in temperature to 300° C. at 10° C./min and held at 300° C. for 20 minutes. The weight loss was calculated by the following Expression:

M=(M1−M0)/M0

where M0 is the weight before processing, M1 is the weight after the processing, and M is the weight loss rate (%).

### <Evaluation Method of UV-Absorbing Ability>

For the obtained optical film, the light transmittance thereof at 380 nm was measured by using Hitachi spectrophotometer U-4100 manufactured by Hitachi High-Technologies Corporation.

### <Evaluation of External Appearance Defect of Film>

The film formed by performing coextrusion or extrusion by a uniaxial extruder was observed, and the number of external appearance defects which can be seen on the film was observed.

©: No external appearance defects are observed by visual observation.

◯: External appearance defects each with a diameter (longer diameter in the case of an oval shape) of less than 0.1 mm are observed.

x: External appearance defects each with a diameter (longer diameter in the case of an oval shape) of 0.1 mm or more are observed over the entire surface.

xx: Many external appearance defects each with a diameter (longer diameter in the case of an oval shape) of 0.1 mm or more are observed over the entire surface.

### <Evaluation of Attached Substance on Roll>

The presence or absence of the attached substance on a cast roll at the outlet of a T-die was observed.

∘: No attached substances on a cast roll are observed.

x: Attached substance(s) on a cast roll is/are observed.

### Reference Example 1

5 wt % of a triazole-based UV absorber (manufactured by ADEKA Corporation, Adekastab LA-31), 0.3 wt % of a phenol-based antioxidant (manufactured by ADEKA Corporation, Adekastab AO-60), and 0.3 wt % of a thioether-based antioxidant (manufactured by ADEKA Corporation, Adekastab AO-412S) with respect to a lactone ring-containing acrylic resin pellet described in JP 2005-146084 A were mixed by a biaxial kneader at 250° C., whereby a resin pellet (1) was produced.

### Reference Example 2

1 wt % of a triazole-based UV absorber (manufactured by ADEKA Corporation, Adekastab LA-31), 0.3 wt % of a phenol-based antioxidant (manufactured by ADEKA Corporation, Adekastab AO-60), and 0.3 wt % of a thioether-based antioxidant (manufactured by ADEKA Corporation, Adekastab AO-412S) with respect to an acrylonitrile-styrene copolymer resin (manufactured by Asahi Kasei Chemicals Corporation, STYLAC AS) pellet were mixed by a biaxial kneader at 250° C., whereby a resin pellet (2) was produced.

### Reference Example 3

1.0 wt % of a triazole-based UV absorber (manufactured by ADEKA Corporation, Adekastab LA-31), 0.3 wt % of a phenol-based antioxidant (manufactured by ADEKA Corporation, Adekastab AO-60), and 0.3 wt % of a thioether-based antioxidant (manufactured by ADEKA Corporation, Adekastab AO-412S) with respect to a polycarbonate resin (manufactured by Mitsubishi Engineering-Plastics Corporation, NOVAREX) pellet were mixed by a biaxial kneader at 250° C., whereby a resin pellet (3) was produced.

### Reference Example 4

0.3 wt % of a phenol-based antioxidant (manufactured by ADEKA Corporation, Adekastab AO-60), and 0.3 wt % of a thioether-based antioxidant (manufactured by ADEKA Corporation, Adekastab AO-412S) with respect to a polyethylene naphthalate resin (manufactured by Teijin Chemicals Ltd., Teonex) pellet were mixed by a biaxial kneader at 280° C., whereby a resin pellet (4) was produced.

### Reference Example 5

A polyvinyl alcohol film having a thickness of 80 μm was dyed in a 5 wt % of an iodine aqueous solution (weight ratio: iodine/potassium iodide=1/10). Then, the resultant polyvinyl alcohol film was immersed in an aqueous solution containing 3 wt % of boric acid and 2 wt % of potassium iodide. Further, the polyvinyl alcohol film was stretched by 5.5 times in an aqueous solution containing 4 wt % of boric acid and 3 wt % of potassium iodide, and thereafter, the polyvinyl alcohol film was immersed in a 5 wt % of a potassium iodide aqueous solution. After that, the polyvinyl alcohol film was dried in an oven at 40° C. for 3 minutes to obtain a polarizer having a thickness of 30 μm.

### Example 1

The resin pellet (1) obtained in Reference Example 1 and the resin pellet (2) obtained in Reference Example 2 were dried at 800 Pa and 100° C. for 12 hours. After that, by using two uniaxial extruders, the resultants were each formed into a film by being subjected to coextrusion from a T-die of a feed block type at a die temperature of 280° C. Then, the resultants were subjected to fixed-end simultaneous biaxial stretching with a biaxial stretching machine, whereby an optical film (1) having a total film thickness of 50 μm, which has a film structure of “resin layer formed of resin pellet (2)/resin layer formed of resin pellet (1)/resin layer formed of resin pellet (2)” was obtained.

Table 1 shows the results of the optical film (1).

### Example 2

Drying, film forming, and stretching were performed in the same manner as in Example 1 except that the acrylonitrile-styrene copolymer resin (manufactured by Asahi Kasei Chemicals Corporation, Stylac AS) was used instead of the resin pellet (2), whereby an optical film (2) having a total film thickness of 50 μm, which has a film structure of “resin layer formed of acrylonitrile-styrene copolymer resin/resin layer formed of resin pellet (1)/resin layer formed of acrylonitrile-styrene copolymer resin” was produced.

Table 1 shows the results of the optical film (2).

### Example 3

Drying, film forming, and stretching were performed in the same manner as in Example 1 except that the resin pellet (3) was used instead of the resin pellet (2) and the drying was performed at a temperature of 120° C. and for 5 hours, whereby an optical film (3) having a total film thickness of 50 μm, which has a film structure of “resin layer formed of resin pellet (3)/resin layer formed of resin pellet (1)/resin layer formed of resin pellet (3)” was produced.

Table 1 shows the results of the optical film (3).

### Example 4

Drying, film forming, and stretching were performed in the same manner as in Example 1 except that the resin pellet (4) was used instead of the resin pellet (2) and the drying was performed at a temperature of 120° C. and for 5 hours, whereby an optical film (4) having a total film thickness of 50 μm, which has a film structure of “resin layer formed of resin pellet (4)/resin layer formed of resin pellet (1)/resin layer formed of resin pellet (4)” was produced.

Table 1 shows the results of the optical film (4).

### Comparative Example 1

The resin pellet (1) obtained in Reference Example 1 was dried at 800 Pa and 100° C. for 12 hours. After that, by using a uniaxial extruder, the resultant was formed into a film by being subjected to extrusion from a T-die at a die temperature of 280° C. Then, the resultant was subjected to fixed-end simultaneous biaxial stretching with a biaxial stretching machine, whereby an optical film (C1) having a total film thickness of 50 μm was obtained.

Table 1 shows the results of the optical film (C1).

TABLE 1

| | | | Thicknesses of | | | Evaluation | Evaluation |
|---|---|---|---|---|---|---|---|
| | Total film | Thickness of | outermost layers | | Light | of external | of attached |
| | thickness | intermediate | One of the | The other | transmittance | appearance | substance |
| | (μm) | layer (μm) | layers (μm) | layer (μm) | at 380 nm (%) | defect of film | on roll |
| Example 1 | 50 | 42 | 4 | 4 | 0.5 | ⊚ | ◯ |
| Example 2 | 50 | 42 | 4 | 4 | 1.0 | ⊚ | ◯ |
| Example 3 | 50 | 42 | 4 | 4 | 1.3 | ◯ | ◯ |
| Example 4 | 50 | 42 | 4 | 4 | 0.4 | ◯ | ◯ |
| Comparative | 50 | 50 | Absent | Absent | 3.0 | XX | X |
| Example 1 | | | | | | | |

### Example 5

### Adhesive

An aqueous solution of a polyvinyl alcohol-based adhesive was prepared by adding an aqueous solution containing 20 parts by weight of methylolmelamine with respect to 100 parts by weight of a polyvinyl alcohol resin with a denatured acetoacetyl group (acetylation degree: 13%) so as to have a concentration of 0.5 wt %.

### (Production of Polarizing Plate)

The optical film (1) obtained in Example 1 was attached to both surfaces of the polarizer obtained in Reference Example 5 using a polyvinyl alcohol-based adhesive. The polyvinyl alcohol-based adhesive was applied onto an optical film (1) side, followed by drying at 70° C. for 10 minutes, to obtain a polarizing plate.

### (Pressure-Sensitive Adhesive)

As a base polymer, a solution (solid content: 30%) containing an acrylic polymer with a weight average molecular weight of 2,000,000 formed of a copolymer of butyl acrylate:acrylic acid:2-hydroxyethyl acrylate=100:5:0.1 (weight ratio) was used. To the acrylic polymer solution, 4 parts of COLONATE L manufactured by Nippon Polyurethane Co., Ltd., which was an isocyanate-based polyfunctional compound, 0.5 part of an additive (KBM 403 manufactured by Shin-Etsu Chemical Co., Ltd.), and a solvent (ethylacetate) for adjusting the viscosity were added with respect to 100 parts of a polymer solid content, to thereby prepare the pressure-sensitive adhesive solution (solid content: 12%). The pressure-sensitive adhesive solution was applied onto a releasing film so that the thickness of the layer was 25 μm after drying (polyethylene terephthalate base material: Dia Foil MRF38 manufactured by Mitsubishi Chemical Polyester Film Co., Ltd.), followed by drying in a hot-air circulation type oven, to thereby form a pressure-sensitive adhesive layer.

### (Polarizing Plate Anchor Layer)

A polyethyleneimine adduct of polyacrylate (Polyment NK380 manufactured by Nippon Shokubai Co., Ltd.) was diluted 50-fold with methylisobutylketone. The resultant polyethyleneimine adduct was applied onto one side of the polarizing plate by using a wire bar (#5) so that the thickness after drying was 50 nm, followed by drying.

### (Production of a Pressure-Sensitive Adhesive Type Polarizing Plate)

A releasing film with the pressure-sensitive adhesive layer formed thereon was attached to the polarizing plate anchor layer, to thereby produce a pressure-sensitive adhesive type polarizing plate.

### (Evaluation of Polarizing Plate)

The adhesive property between the film and the polarizer of the obtained polarizing plate, and the external appearance thereof were evaluated. It was revealed that the adhesive property was favorable and the polarizer and the film were integrated with each other and did not peel from each other. Further, the evaluation result of the external appearance was “o”.

### INDUSTRIAL APPLICABILITY

The polarizer protective film and the polarizing plate of the present invention can be preferably used for various kinds of image display apparatuses (liquid crystal display apparatus, organic EL display apparatus, PDP, etc.).

1. A polarizer protective film comprising, in the following order:
a resin layer (A); and
a resin layer (B1), wherein:
the resin layer (A) is a resin layer containing a (meth)acrylic resin as a main component and contains a UV absorber at a ratio of 0.5 to 10 wt % with respect to a resin component contained in the resin layer (A); and
the resin layer (B1) is a resin layer containing, as a main component, a thermoplastic resin other than a (meth)acrylic resin.

2. A polarizer protective film according to claim 1, wherein the resin layer (B1) contains a UV absorber at a ratio of more than 0 wt % and 2 wt % or less with respect to a resin component contained in the resin layer (B1).

3. A polarizer protective film according to claim 1, wherein a content ratio of the UV absorber in the resin layer (B1) is less than a content ratio of the UV absorber in the resin layer (A).

4. A polarizer protective film according to claim 1, wherein:
the resin layer (B1) has a thickness of 0.5 to 15 μm; and
the resin layer (A) has a thickness of 5 to 70 μm.

5. A polarizer protective film according to claim 1, wherein the thermoplastic resin other than a (meth)acrylic resin comprises at least one kind selected from a polyamide-based resin, a polycarbonate-based resin, a polystyrene-based resin, a polyolefin-based resin, a polyester-based resin, a polyether-based resin, and a polyphenylene-based resin.

6. A polarizer protective film according to claim 1, comprising a resin layer (B2) on a resin layer (A) side opposite to a side on which the resin layer (B1) is provided,
wherein the resin layer (B2) is a resin layer containing a thermoplastic resin as a main component.

7. A polarizer protective film according to claim 6, wherein the resin layer (B2) is a resin layer containing, as a main component, a thermoplastic resin other than a (meth)acrylic resin.

8. A polarizer protective film according to claim 7, wherein the thermoplastic resin other than a (meth)acrylic resin comprises at least one kind selected from a polyamide-based resin, a polycarbonate-based resin, a polystyrene-based resin, a polyolefin-based resin, a polyester-based resin, a polyether-based resin, and a polyphenylene-based resin.

9. A polarizer protective film according to claim 6, wherein the resin layer (B2) contains a UV absorber at a ratio of more than 0 wt % and 2 wt % or less with respect to a resin component contained in the resin layer (B2).

10. A polarizer protective film according to claim 6, wherein a content ratio of the UV absorber in the resin layer (B1) and a content ratio of the UV absorber in the resin layer (B2) are each less than a content ratio of the UV absorber in the resin layer (A).

11. A polarizer protective film according to claim 6, wherein:
the resin layer (B1) has a thickness of 0.5 to 15 μm;
the resin layer (A) has a thickness of 5 to 70 μm; and
the resin layer (B2) has a thickness of 0.5 to 15 μm.

12. A polarizer protective film according to claim 1, which has a total thickness of 15 to 100 μm.

13. A polarizer protective film according to claim 1, which has a light transmittance at 380 nm in a thickness of 50 μm of 10% or less.

14. A polarizer protective film according to claim 1, which is produced by a coextrusion molding.

15. A polarizing plate, comprising:
a polarizer formed of a polyvinyl alcohol-based resin; and
the polarizer protective film according to claim 1.

16. A polarizing plate according to claim 15, wherein an adhesive layer is formed between the polarizer protective film and the polarizer.

17. A polarizing plate according to claim 16, wherein the adhesive layer is formed of a polyvinyl alcohol-based adhesive.

18. A polarizing plate according to claim 15, further comprising a pressure-sensitive adhesive layer on at least one side of resin layers.

19. An image display apparatus, comprising at least one of the polarizing plates according to claim 15.
